(19) United States
(12) Patent Application Publication
(10) Pub. No.: US 2002/0018275 A1
(43) Pub. Date: Feb. 14, 2002

(54) Focusing mechanism and method of scanner

(76) Inventor: Chih-Wen Huang, Hsinchu (TW)

Correspondence Address: Raymond Sun, 12420 Woodhall Way, Tustin, CA, 92782, US

(21) Appl. No.: 09/826,625

(22) Filed: Apr. 5, 2001

(30) Foreign Application Priority Data
Jul. 7, 2000 (TW) 89113470

(51) Int. Cl. G02B 26/08

(52) U.S. Cl. 359/205; 359/226

(57) ABSTRACT

A Focusing Mechanism and Method of Scanner. The scanner includes a case, a cover, a manuscript plate and an optical device. The optical device consists of a case, plural reflection mirrors, a lens and a charge couple device. The scanner uses the reflection mirror to receive the test image and to make image in the charge couple device through the lens focusing. During the process, it generates induced voltage. The characteristic is that the angle of the above reflection mirror is adjustable and it can change the induced voltage in the charge couple device according to the angle until the charge coupling component gets the best image definition. By the time, it finishes the focusing of the scanner.

### FIELD OF THE INVENTION

This invention relates a focusing method and device of the scanner, more particularly for that adjusting the angle of the reflection mirror inside the optical device to make the charge couple device getting the best resolution.

### BACKGROUND OF THE INVENTION

Scanner is normal computer peripheral equipment. Its main function is to grab the paper image and transfer the image to digital signals so that they can be transmitted to the computer for further image process. Please refer to FIG. 1, showing prior art of an optical device 1 inside the scanner. It includes a light tube 11, plural reflection mirrors 12, a lens 13 and a charge couple device 14(CCD). The optical device 1 lies below a transparent manuscript plate 15, which can carry the papers 16 waiting to be scanned. The plural reflection mirrors 12 include a first reflection mirror 121, a second reflection mirror 122 and a third reflection mirror 123. The scanner uses the light tube 11 to illuminate the papers 16 on the manuscript plate 15 and uses the first reflection mirror 121 to receive the reflection image from the papers 16 (as the dash lines show). Then under the guidance of the second reflection mirror 122 and the third reflection mirror 123, it makes the image in the charge couple device 14 by focusing of the lens 13 and makes that the charge couple device 14 generates optical voltage.

Generally speaking, the lighter (white) scan color generates the higher induced photo- voltage and the darker (black) scan color generates the lower induced photo-voltage. So, for a scanner, if we define the induced voltage as 0 when scanning the totally black image, it will get better scan quality because scanning totally white image generates higher induced voltage. Before the assembled scanner being delivered, a standard test chart (black and white strips spaced in-between) is used to focus and make the induced voltages lying in an appropriate range. It means it has to maintain the scan resolution and the contrast (or clarity) all in an appropriate range so that the scan quality can have specific level. The focusing method is mainly to adjust the relative position of each component inside the optical device. However, the design of the scanner using prior art fixes the reflection mirror in the optical device so when the scanner is focusing, it only can make appropriate changes according to the relative positions of the lens and the charge couple device to make the charge couple device getting the best induced voltage. But, because the prior art has to move two components at the same time, it's more difficult to precisely locate the positions of the two components and the adjusting mechanism for two components moving at the same time is more complicated and expensive. In fact, for a scanner, the adjustment of the angle (or position) of the reflection mirror also changes the induced voltage of the charge couple device, especially for the scanner with high resolution. Please refer to FIG. 2, from the figure we know the brightness distribution of the papers image changes with the position. If the papers image brightness according to the angle of the reflection mirror is not the maximum value, the induced voltage in the charge couple device cannot be increased. So if we want to increase the clarity of the scanner, besides adjusting the positions of the lens and the charge couple device, the adjustment of the angle (position) of the reflection mirror cannot be ignored.

### SUMMARY OF THE INVENTION

The main object of the invention is to provide a focusing mechanism and method of the scanner, which can increase the clarity and the scan quality by adjusting the angle of reflection mirror.

The present invention includes a case, a cover, a manuscript plate and an optical device. The optical device consists of a light source, a case, plural reflection mirrors, a lens and a charge couple device. The internal surface of the outer case has a test chart. When it covers the manuscript plate, the test chart image can make image in the charge couple device through the transmission of the reflection mirror and the lens focusing. The characteristic is that the angle of the reflection mirror is adjustable and the angle of the reflection mirror can be adjusted according to the induced voltage in the charge couple device until that the charge couple device gets the best induced voltage. At that time, the scanner gets the best scan clarity and finishes the focusing to get the best scan quality.

### BRIEF DESCRIPTION OF THE DRAWINGS

These and other features and advantages of the present invention will be better understood by the reference to the following detailed description when considered in connection with the accompanying drawings wherein:

FIG. 1 is the illustration of the optical device inside the scanner according to prior art.

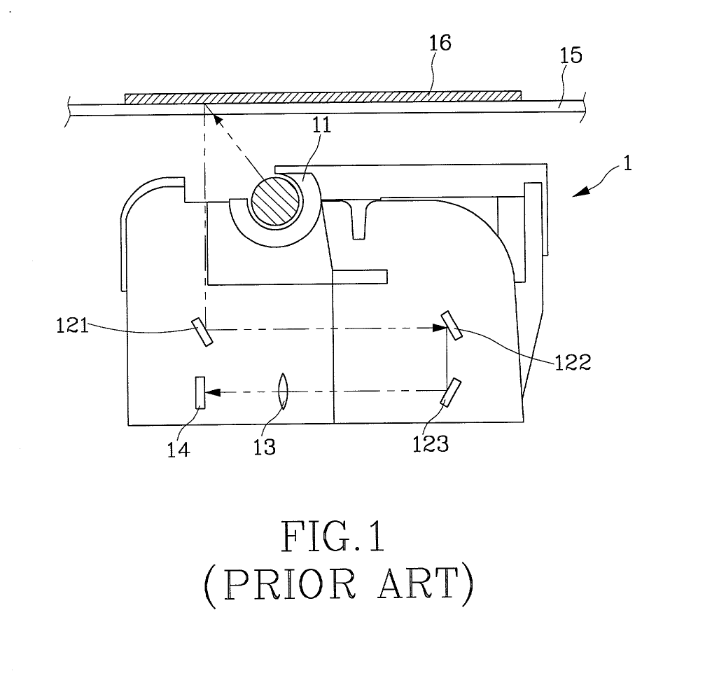

FIG.2 is the relationship between the brightness and the position according to prior art.

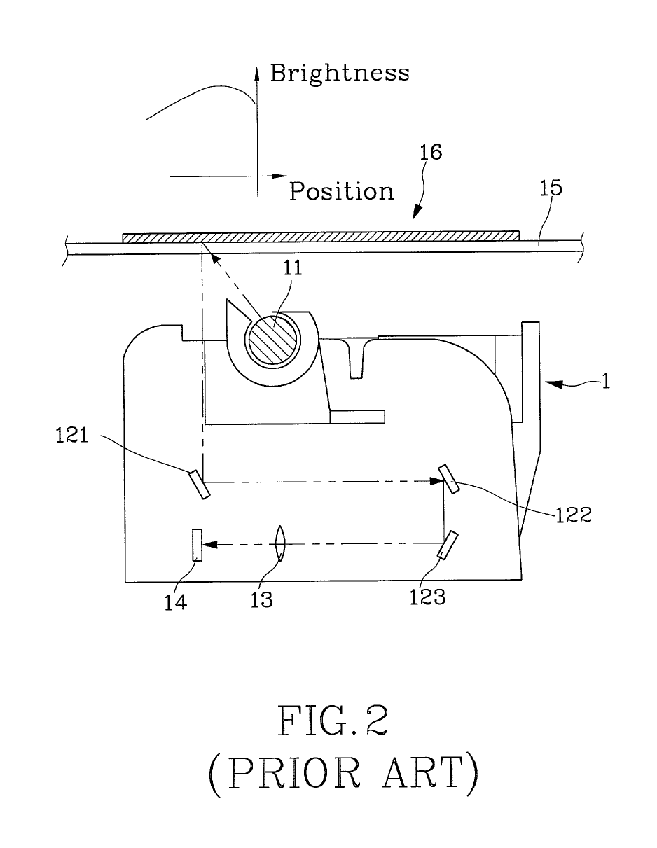

FIG.3 is the illustration of the scanner in this invention.

FIG.4 is the illustration of the optical device in this invention.

FIG.5 is the flow chart of the focusing of the scanner in this invention.

### DETAILED DESCRIPTION OF THE PREFERRED EMBODIMENT

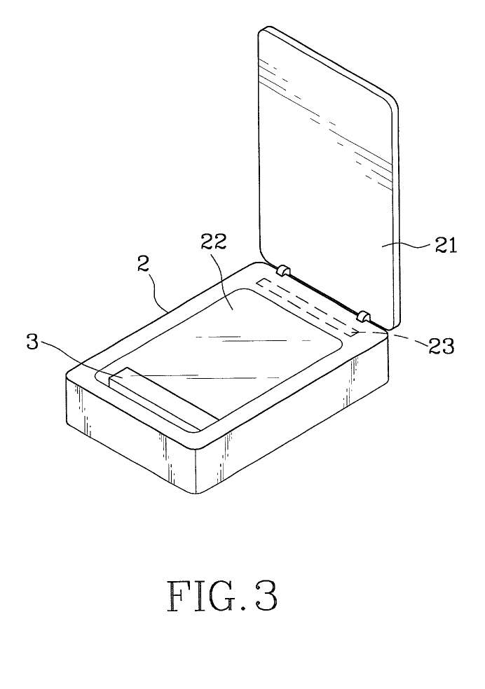

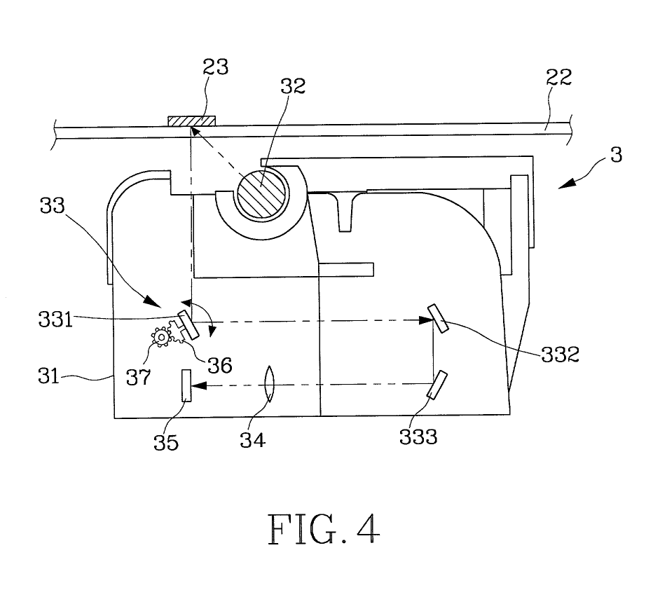

In the background description, we mentioned the main reason influencing the clarity of the scanner is related to the arrangement of the relative positions of the components inside the optical device. While the focusing method of the prior art mainly stresses the adjustment of the positions between the lens and the charge couple device. But, if moving the lens and the charge couple device does the adjustment, we have to consider the relative positions of the lens and the charge couple device at the same time. The precise positioning is difficult and the mechanism for two components moving at the same time is more complicated and expensive. The clarity improvement is also limited. We will not describe it any more in this invention and will stress the angle adjustment of the reflection mirror to get better scan quality. Please refer to FIG.3, which is the scanner in this invention. It includes a case 2, an outer cover 21, a manuscript plate 22 and an optical device 3. The manuscript plate 22 lies above the case 2 and the optical device 3 lies inside the case 2. There is a standard test chart 23 having black and white strips spaced in-between in the appropriate position of the scanner. Or the test chart 23 can be put above the manuscript plate 22 so that the optical device 3 can do scanning and focusing to the test chart 23 when adjusting of the resolution and the clarity (contrast). Please refer to FIG.4, the optical device 3 consists of a case 31, a light tube 32, plural reflection mirrors 33, a lens 34 and a charge couple device 35. The reflection mirrors 33 are the best with three of individually defined as first reflection mirror 331, second reflection mirror 332 and third reflection mirror 333. The plural reflection mirrors 33 can receive the reflection image by light tube 32 scanning (illuminating) the test chart 23 and transmit the image to the lens 34, and make image in the charge couple device 35 through focusing to make the charge couple device 35 generating induced voltage.

The characteristic of this invention is that the two endpoints of the first reflection mirror 331 of the reflection mirror 33 are connected to the case 31 and there is an adjusting wheel 36 at the connection of the first reflection mirror 331. The adjusting wheel 36 is turned by hand to adjust the angle of the first reflection mirror 331 to make the charge couple device 35 getting the best scan clarity (e.g. making the induced voltage maintain in the best range). Or it uses a feedback circuit (not shown in the figure) according to the feedback of the induced voltage in the charge couple device 35 to drive a motor 37 for controlling the rotating angle of the adjusting wheel 36 (first reflection mirror 331) until that the charge couple device 35 generates the maximum induced voltage. In the optical device 3, the adjusting wheel 36 can be located at one side of the 3 reflection mirrors 33 or just located at one side of the first reflection mirror 331.

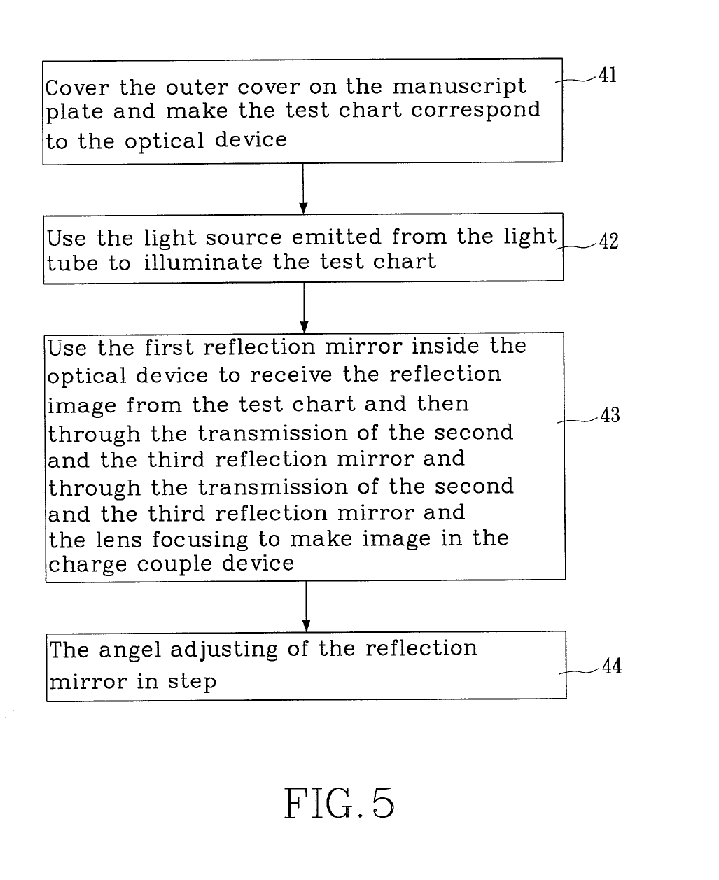

Please refer to FIG.5, which is the flow chart of the focusing method of the scanner in this invention. The steps include: Covering the outer cover on the manuscript plate and making the test chart correspond to the optical device (41) and using the light source emitted from the light tube to illuminate the test chart (42). Using the first reflection mirror inside the optical device to receive the reflection image from the test chart, and then through the transmission of the second and the third reflection mirror and the lens focusing to make image in the charge couple device (43). According to the induced photo-voltage in the charge couple device to adjust the angle of the reflection mirror till the charge couple device generates the best (or maximum) photo-voltage. At that time, the focusing of the scanner is finished and the scan quality of the scanner is the best.

The angle adjusting of the reflection mirror in step (44) can be done to three reflection mirrors at the same time or just to the first reflection mirror. Besides, plural teeth can be put at the outer edge of the adjusting wheel and to control the rotating angles of the reflection mirror by turning the teeth. The condition for more teeth is more precise, and then the angle of the reflection mirror is smaller, it is changed by turning one tooth and then the focusing result is better. So, as long as the scanner is driven to scan the test chart, it can do the focusing to make the scanner maintain the best situation.

It will be apparent to those skilled in the art to which the specification is addressed that the embodiment therefore described may be varied to meet particular specialized requirements without departing from the true spirit and scope of the invention disclosed. The foregoing embodiment is therefore not limited but rather exemplary of the structures and manner in which the present invention may be implemented. Instead, the scope of the invention is defined by the spirit and language of the appended claims.

What is claimed is

1. A focusing mechanism of scanner includes:
a case, which is a shell case;
a manuscript plate, which is transparent on the case;
a cover, which is connected on the case and can be used to cover the manuscript plate;
and an optical device, which is inside the case and includes plural reflection mirrors;
the image from the reflection of the light emitted from the light tube to a scanned object is reflected by plural reflection mirrors, and then goes through the focusing of a set of lenses makes image in a charge couple device to make the charge couple device generating induced voltage; the characteristic is: the angle of at least one reflection mirror in the plural reflection mirrors should be adjustable to adjust the clarity of the image in the charge couple device.

2. A focusing mechanism of scanner as claimed in claim 1, wherein a test chart is set in an appropriate position in scanner, and the scanned object is the test chart.

3. A focusing mechanism of scanner as claimed in claim 1, wherein the test chart is a black and white spaced in-between chart.

4. A focusing mechanism of scanner as claimed in claim 1, wherein the optical device includes a case and a light tube. The reflection mirror with the angle adjustable is connected to the case and the light tube offers the light source for optical device scanning.

5. A focusing mechanism of scanner as claimed in claim 1, wherein the plural reflection mirrors include a first reflection mirror, a second reflection mirror and a third reflection mirror according to the light pathway in order, and there is at least one adjusting wheel set on one end at one of the reflection mirrors to adjust the angle of the reflection mirror.

6. A focusing mechanism of scanner as claimed in claim 1, wherein the plural reflection mirrors include a first reflection mirror, a second reflection mirror and a third reflection mirror according to the light pathway in order, and there is an adjusting wheel on one end of the first reflection mirror to adjust the angle of the reflection mirror.

7. A focusing mechanism of scanner as claimed in claim 5, wherein the adjusting wheel uses a feedback circuit to receive the feedback induced voltage from the charge couple device to control the rotating angle of the reflection mirror.

8. A focusing mechanism of scanner as claimed in claim 6, wherein the adjusting wheel uses a feedback circuit to receive the feedback induced voltage from the charge couple device to control the rotating angle of the reflection mirror.

9. A focusing method of scanner, wherein the scanner includes a light tube offering the light source, an optical device with plural reflection mirrors and a charge couple device, and the focusing methods includes the following steps:
(a)the light tube emits the light to illuminate the scanned object to generate an image;
(b) using the optical device to receive the image and reflecting the image to the charge couple device to transfer to photo-voltage.
(c) adjusting the angle of at least one of the reflection mirrors inside the optical device until the photo-voltage of the charge couple device reaches a default value.

10. A focusing method of scanner as claimed in claim 9, wherein the scanned object is a test chart, which has black and white strips spaced in-between.

11. A focusing method of scanner as claimed in claim 9, wherein the test chart is inside the case of the scanner.

12. A focusing method of scanner as claimed in claim 9, wherein the light tube is inside the optical device.

13. A focusing method of the scanner as claimed in claim 9, wherein the optical device includes a lens, wherein the arrangement of the angle and the position, the plural reflection mirrors can make the reflection image in the charge couple device through the lens.

14. A focusing method of scanner as claimed in claim 13 wherein the plural reflection mirrors include a first reflection mirror, a second reflection mirror and a third reflection mirror according to the light pathway in order, and in the step (c), the adjustment of the angle of the reflection mirror is the best to do with the first reflection mirror.

15. A focusing method of scanner as claimed in claim 9 wherein the adjustment of the angle of the reflection mirror inside the optical device is done by hand.

16. A focusing method of scanner as claimed in claim 9 wherein the scanner includes a feedback circuit, and the feedback circuit can adjust the angle of the reflection mirror according to the feedback voltage from the charge couple device.
